(19) United States
(12) Patent Application Publication
(10) Pub. No.: US 2013/0289345 A1
(43) Pub. Date: Oct. 31, 2013

(54) MALE MASTURBATION AID

(71) Applicant: Francisco Dorronsoro Rueda, Malaga (ES)

(72) Inventor: Francisco Dorronsoro Rueda, Malaga (ES)

(73) Assignee: WE ARE YOU PATNERSHIP SOLUTIONS, S.L., Malaga (ES)

(21) Appl. No.: 13/979,903

(22) PCT Filed: Jan. 17, 2011
(86) PCT No.: PCT/ES2011/070023

§ 371 Date: Jul. 16, 2013

(51) Int. Cl. A61H 19/00

(52) U.S. Cl. CPC A61H 19/00
USPC 600/38

(57) ABSTRACT

The Male Masturbating Device is formed by a diversity of rings (1), all fitted with coupling elements between them, that form a tubular body (4). Each ring presents an internal different specific design and their joints make the orifice (8) or space where the penis is introduced in order to perform the masturbating act.

### TECHNICAL DETAILS

The purpose of this invention, as described in the title of this document, refers to a male masturbator device, this being a sex toy with a long body fitted with an orifice in which the penis is introduced, and including a group of assembled elements in different positions, that gives it its long shape.

### HISTORY

Female and male masturbation, are explained as the stimulation of the genital organs with the goal of obtaining pleasure, and the possibility of reaching climax. Generally it is understood as self sexual intercourse, although it could be performed towards someone else's genitals with the same purpose.

Male masturbation is often done with the hands or by using a suitable object that causes friction, these know as sex toys that help reaching the excitement.

In particular, these types of sex toys consist in a shape or form fitted with an orifice where the penis is introduced and that have inside a design that stimulates and simulates different sexual techniques.

For the use of these devices, a lubricant gel is recommended and needed. This helps the introduction and intensifies the friction with the internal shape, being the climax and the ejaculation the final goal.

After the use, this sex toy must be thoroughly cleaned in order to eliminate any residue.

The devices that are mainly known are ES 2107054, EP 2168500, US 2006/0264856. These are described as masturbator devices formed by a body or shape fitted with an orifice where the penis is introduced and that after each use can be cleaned, thus making them re-usable.

Alternatively, one time use masturbator devices have been developed with the aim of improving the hygienic features of the product avoiding the later cleaning process. Examples of this last type are EP1891923, EP 1897519, JP2006340871.

The problem that needs solving: Current devices do not allow to modify the internal setting/placing of the orifice where the penis is introduced, so each model will only provide a different sensation depending on the morphologic internal design. This according to the user's preferences and their physical characteristics will result in more or less suitable in relation to their taste and measurements.

### INVENTION DESCRIPTION

This male masturbator novelty device solves in an original and simple way the above mentioned problem, allowing the user to choose and modify the structure and internal design of the orifice, as well as the length and width dimensions. All these being possible with a re-usable device, easy maintained and at a reduced price.

This novelty masturbator device is made with several rings, fitted with an interlinked system, forming a tubular body, mainly circular, although it could also be polygonal according to the needs of the external design.

Each ring presents an internal designed section that through the association of the different rings forms the orifice or space where the penis is introduced in order to perform the sexual intercourse.

The different ring layout allows the multiple different settings of the orifice. At the same time, the quantity of selected rings as well as the internal diameter give the user the choice to adapt the device to their needs and suitable size.

The possibility of modifying the internal structure of the masturbating device according to the user's preferences opens up new opportunities for marketing this type of product, that has now became an updatable kit, able to incorporate new elements that contribute the final purpose.

At the same time, the possibility of modifying its thickness and internal diameter, makes the total adaptation to the end user even easier.

In a preferential realization, the internal section of each ring is made by an added part adapted to the external ring with fixed or removable ways of retention. This preferential setting allows the texture and hardness of the interior ring to be completely different to the one inside the external ring. This way, the device external side can be hard and tough while the interior can be soft and elastic.

The external rings, as an structure element will be rigid or semi-rigid and alternatively they can be soft with the purpose of putting pressure on with the hand thus feeling same pressure in the penis. At the same time the flexibility of the external ring allows the device to be curved or bended achieving free movements in different ways, for example swiveling or twisting movements.

The tubular body formed by the association of rings, is closed in one of the extremes by a dome piece adaptable to the same means of coupling that fix the rings.

Another advantage of this new design, is the possibility of adding new accessories such as vibrating devices, vacuum/sucking devices, strangulating devices and even self release lubricant deposits.

To the above mentioned advantages due to its versatility and multiple settings, we add the easy maintenance, as it is able to be totally cleaned after its use. This is possible as the rings can come apart for easy access to the internal structure. At the same time, this perfect access to the interior allows to user to inspect the status of the material, noticing in advanced if any there are little tears that might cause any injury. In such a case we discover another advantage, the possibility of replacing the damaged rings and not disposing the whole device.

The rings means of fixing are of mechanical type.

In a preferential realization, these means are fixed by a dovetail joint, with a ribbing on one side and a groove on the other. The grooved & ribbed sections match, in a way that the ribbing of the first ring can be inserted in the groove of the second ring, ending in a firm conjunction but allowing the rotation between them

In another preferential realization, the means of fixing are set in a threaded system, existing a male nut on one side of the ring, and a female nut on the opposite side. In the same way of the previous preferential realization, the join between the rings is performed via the association of the male element of the first ring system with the female element of the second ring.

Any other means of fixing between rings is not yet discarded, for example bayonets, harpoons, magnets . . . etc

### DRAWING DESCRIPTION

FIG. 1 shows a section view of the new masturbator device.

FIG. 2 shows an exploded view of same section.

FIG. 3 corresponds to a detailed view of the grooved dome.

FIG. 4 corresponds to a detailed view of the ring section.

FIG. 5 corresponds to a detailed view of the ribbed lid.

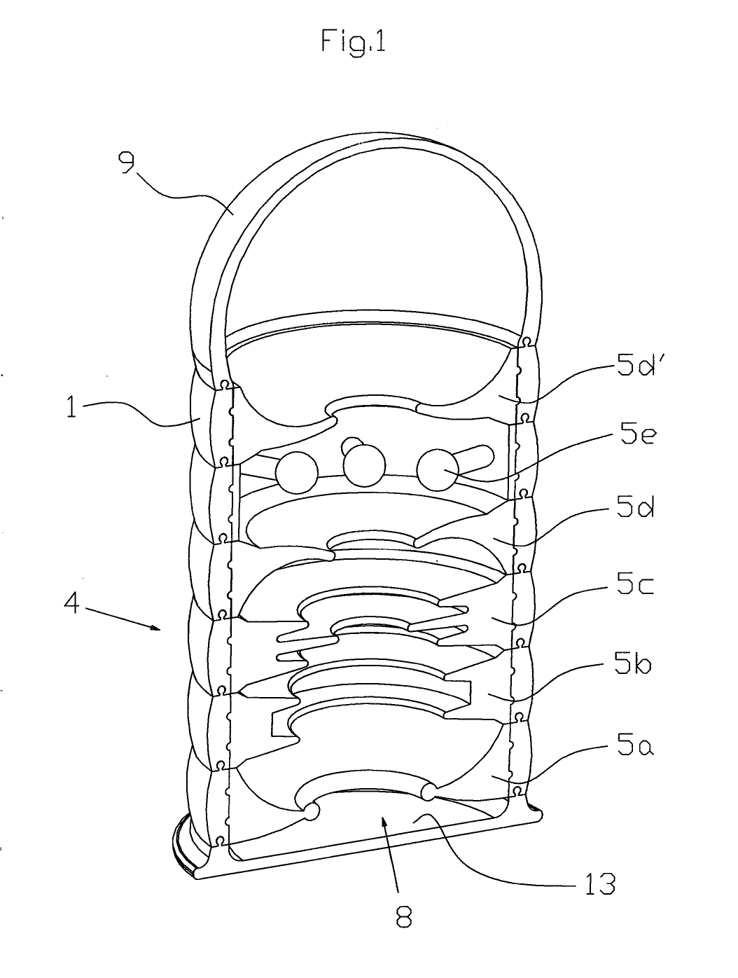

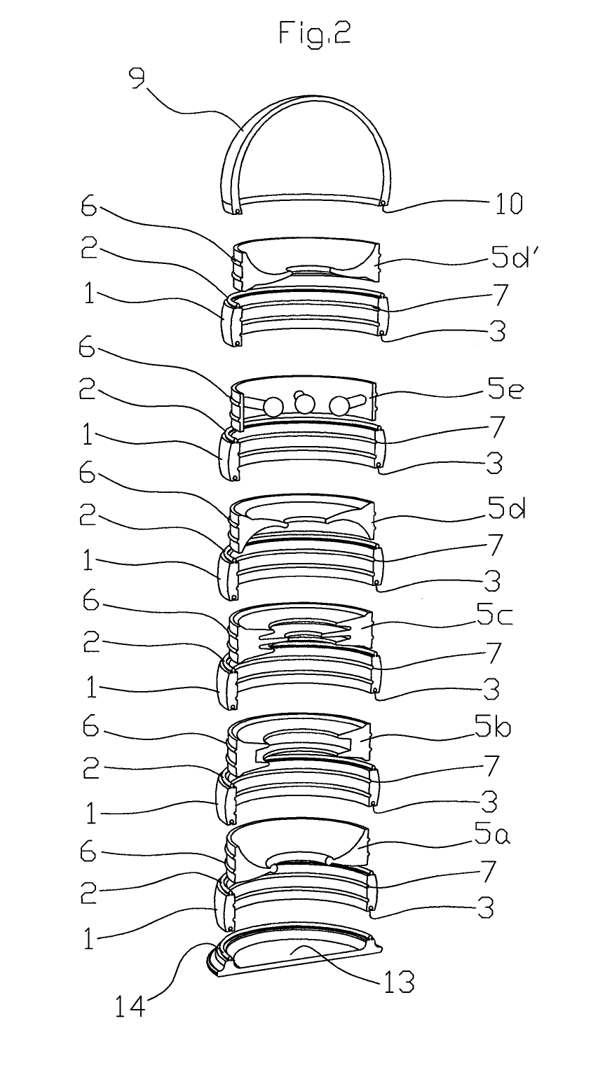

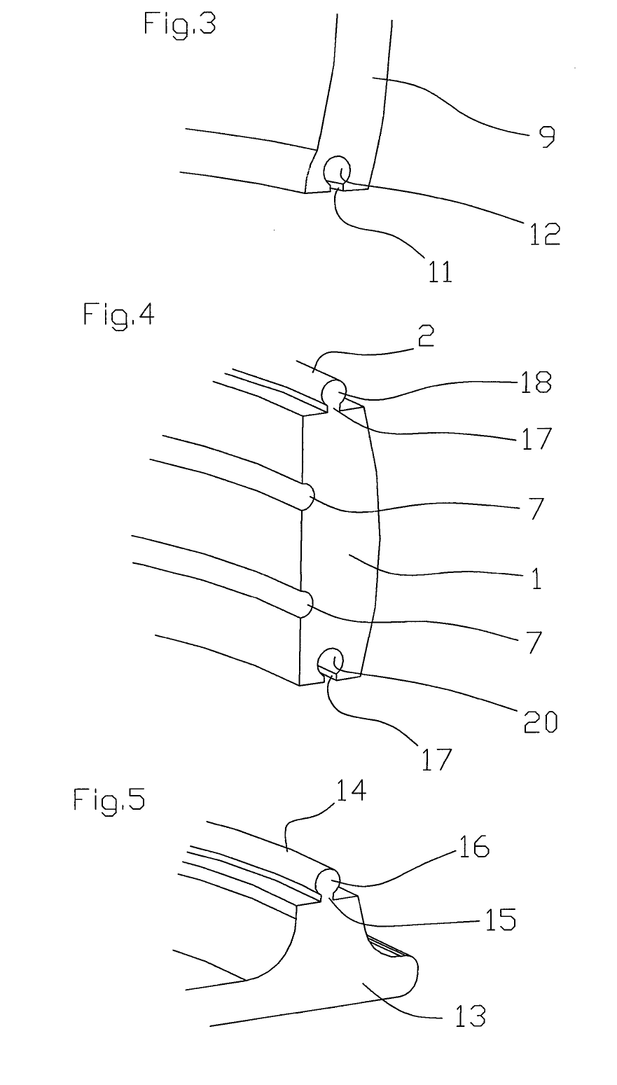

### DESCRIPTION OF A SAMPLE STUDY

In the figure drawings enclosed to this document, we develop a sample study of making the device object of this document.

This novelty male masturbator device is made as explained in the drawing, by a diversity of tough rigid or semi-rigid rings (1), fitted with a perimeter ribbing (2) performed on the side of the ring and a perimeter groove (3) performed on the opposite side.

The grooved and ribbed sections meet in a way that the ribbing of one ring can be inserted in the groove of the other, ending in a solid joint, but maintaining the rotary ability. In particular, each perimeter ribbing (2) presents a straight section at the beginning (17) with a circular end (18) while the perimeter groove presents a straight section at the beginning (19) with a circular end (20). This setting allows the coupling and retention of the ribbings and grooves between the different rings.

This ribbing (2) and groove (3) form an association between rings (1) in order to make a tubular body with a circular section.

Each ring (1) presents a section formed by an added part (5) which is soft and elastic, and that gets inserted in the external ring (1) with removable means of retention. These means are formed by a group of two perimeter ribbings (6) situated in the external side of the added part (5) and two perimeter grooves (7) situated in the internal side of the external ring (1). The section and position of the grooves (7) and the ribbings (6) are coincident, in a way that when the added part gets inserted (5) in an external ring (1), this one stays fixed in an stable position.

The internal section of each added part (5) presents an specific design. In particular, in the illustrated example it shows 4 different models (5a) (5b) (5c) (5d), from which one of them can be situated in two positions (5d) and (5d's).

Through the association of the external different rings (1) with their corresponding added parts (5) inserted, the orifice (8) gets formed, and it is where the penis is introduced in order to perform the masturbating act.

The tubular body with circular section (4) is closed on one of the extremes by a dome shape piece (9), and this is fitted with a groove in its lower side (10) in which an initial straight section can be distinguished (11) and it is ended in a circular area (12). This setting of the groove allows the coupling with the perimeter ribbings (2) of the rings.

Finally, the device incorporates a closing lid (13) for conservation, fitted in its upper side with a perimeter ribbing (14) in which an initial straight section can be distinguished (15) and it is ended in a circular area (16). This setting of the ribbing allows the coupling with the perimeter grooves (3) of the rings (1).

1. Male Masturbating Device characterized in that it comprises a diversity of rings (1), fitted with coupling means between them, forming a tubular body (4), and each ring has an internal different section with specific designs that joins in order to create the orifice (8) or space where the penis is introduced to perform the masturbating act.

2. Male Masturbating Device according to claim 1, characterized in that each internal section of the rings is formed by an added part (5a, 5b, 5c, 5d, 5d′, 5e) inserted in the external ring (1) and fixed with retention means.

3. Male Masturbating Device according to claim 1, characterized in that the tubular body (4) is formed by the ring association (1) and it is closed in one of the extremes with a dome shaped piece (9) fitted with coupling means adaptable to the same means of fixing between the rings (1).

4. Male Masturbating Device according to claim 1, characterized in that the coupling means that fix the rings (1) have a ribbing area (2) disposed on the side of the ring (1) in combination with a groove area (3) disposed on the opposite side, being both coincident areas (3 and 2), such that the ribbing of the first ring (1) can be inserted in the groove (3) of a second ring (1).

5. Male Masturbating Device according to claim 4, characterized in that the ribbing (2) disposed on the side of the ring (1) presents an area in which an initial straight section can be distinguished (17) and ends in a circular area (18), while the perimeter groove (3) disposed on the side of the ring (1) presents an area in which an initial straight section can be distinguished (19) and ends in a circular area (20).

6. Male Masturbating Device according to claim 1, characterized in that the coupling means that fix the rings (1) include a male nut on the side of the ring (1) and a female nut on the opposite side in a way that the male nut of the first ring (1) can be screwed in the female nut of the second ring (1).

7. Male Masturbating Device according to claim 3, characterized in that the dome (9), is fitted with a groove in its internal area (10).

8. Male Masturbating Device according to claim 7, characterized in that the grooved section (10) situated in the dome lower area (10) presents an initial straight section (11) ended in a circular area (12).

9. Male Masturbating Device according to claim 4 realization, characterized in that it incorporates a lid with a seal (13) fitted with a perimeter ribbing in its upper area (14).

10. Male Masturbating Device according to claim 9, characterized in that the perimeter ribbing section (14) is situated on the closing lid (13) and presents an initial straight section (15) ended with a circular area (16) that allows coupling of the perimeter grooves (3) of the rings (1).
